(19) United States
(12) Patent Application Publication
(10) Pub. No.: US 2011/0174894 A1
(43) Pub. Date: Jul. 21, 2011

(54) SHOWERHEAD WITH MULTIPLE AERATING ORIFICE PLATES

(76) Inventors: Michael Miller, Portage, MI (US); Shixiong Lin, Xiamen (CN); Lieyong Huang, Xiamen (CN)

(21) Appl. No.: 12/690,138

(22) Filed: Jan. 20, 2010

(51) Int. Cl. B05B 1/14

(52) U.S. Cl. 239/11; 239/548

(57) ABSTRACT

A device for use in a shower head that discharges a fluid, such as water, has a plurality of nozzles, each nozzle having an opening for discharging the fluid and a plurality of apertures spaced away from the opening having a bore through which the fluid flows, and a face through which the opening extends. The nozzles each create droplets that are large enough to retain heat and moving slowly enough to minimize irritation to a user.

### FIELD OF THE INVENTION

This invention relates to showerheads in general and venturi showerheads in particular

### BACKGROUND OF THE INVENTION

Numerous showerheads assemblies are known in the prior art that operate in multi-functional modes. These assemblies provide fixed spray patterns in combination with massaging action generated by either pulsating or whirling the water through the showerhead.

A system may include a selector disk that is rotatably mounted inside the selector housing. The disk selector has an inlet end facing the inlet end of the selector housing, and an outlet end opposite the inlet end of the disk selector. The showerhead includes a selector face mounted inside the selector housing and a diffuser plate mounted inside the selector housing.

Other systems may have a showerhead assembly enabling the selection of various forms of output streams, including a set of streams having a large diameter, rich in bubbles when the water pressure is high, a set of streams having a smaller diameter full of bubbles when the water pressure is low, or a spray instead of the bubbly stream.

Still other systems may use a patterned chip to produce various patterns. And some showers mix in air with the water to make a user feel that, in this “save water” world that he or she is experiencing a higher volume of water when in the shower environment. Another system includes a source of hot water that produces steam. A selectively controlled diverter is disposed within the conduit and diverts the water arriving from the source away from the showerhead and through the outlet in the form of a mist. The showerhead includes a nozzle-driven turbine. Apertures in a flow director plate, governed by a control plate, feed nozzles predetermined to vary the force of water delivered. The water force varies with the number of nozzles that are open.

Some systems are simple however, like the “navy” shower that utilized a single nozzle having a single venturi-like opening feeding water into the nozzle. Some, like the shower head disclosed in U.S. Pat. No. 4,426,040 entitled “Adjustable Aerating Shower Head” to Smith, utilize a single nozzle with multiple openings that vary a pattern by lengthening the nozzle itself. In both of these cases the nozzle must be large to create the proper coverage for a user.

### SUMMARY

An exemplary embodiment includes a device for use in a shower head that discharges a fluid has a plurality of nozzles, each nozzle having an opening for discharging the fluid and a plurality of apertures spaced away from the opening having a bore through which the fluid flows, and a face through which the opening extends. The nozzles each create droplets that are large enough to retain heat and moving slowly enough to minimize completeness to a user.

A further exemplary method for providing a user a comfortable shower from a shower head includes the steps of providing water through a first nozzle of the shower head, the nozzle having an outlet, a bore and a plurality of apertures through which the water flows and providing water through a second nozzle of the shower head and having an outlet, a bore and a plurality of apertures through which the water flows. The nozzles each create droplets that are large enough to retain heat and moving slowly enough to minimize discomfort to a user.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 shows a front perspective view of a handheld showerhead.

FIG. 2 shows a front perspective view of the handheld showerhead of FIG. 1 taken along the line 2-2.

FIG. 3 shows a schematic, cut-away view of the handheld showerhead of FIG. 1.

FIG. 4 shows a schematic, cut-away view of the handheld showerhead of FIG. 3 taken along the line 4-4.

### DETAILED DESCRIPTION OF THE PREFERRED EMBODIMENT

Referring to FIG. 1, an embodiment of a hand-held showerhead 10 is shown. The showerhead 10 has a handle 15 by which the user holds the showerhead, an inlet tube 20, a face 25 and a selector lever 30. The face 25 has a plurality of openings 35 through which various functions, as known in the art, are directed therethrough. The showerhead 10 also has shown six nozzles 40, each nozzle having four openings 50 as will be described herein. Though a hand held shower is shown, the teachings herein are applicable to fixed or permanently mounted showerheads as well.

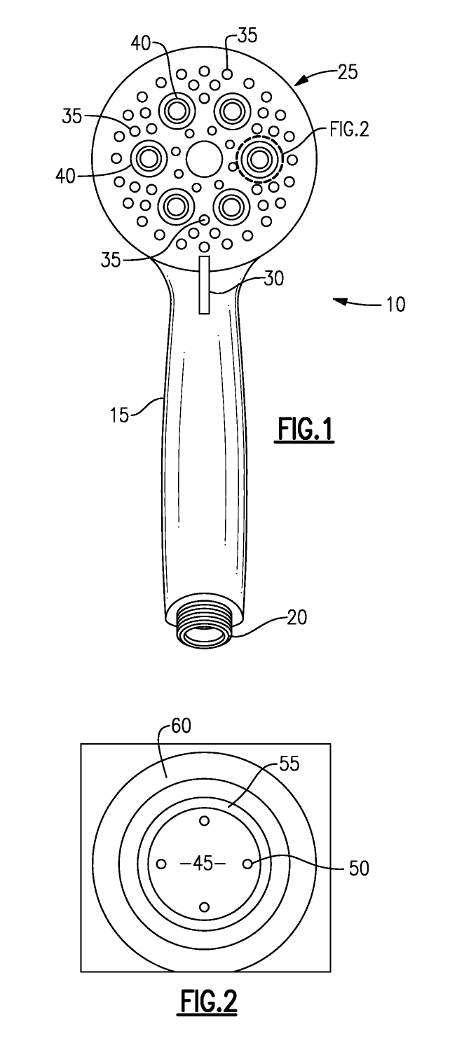

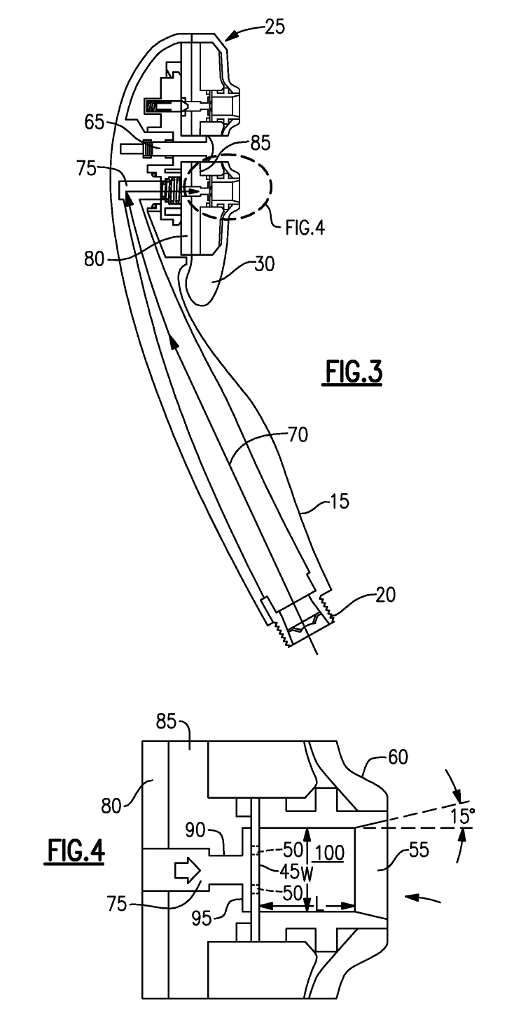

Referring now to FIG. 2, a nozzle 40 of FIG. 1 is shown. Each nozzle has a plate 45 in which four apertures 50 are disposed. Each nozzle has a flared portion (at a 15° angle—see FIG. 4) through which water is directed and an outer boss 60 having decorative purposes.

Referring to FIG. 3, the lever 30 rotates the face 25 about a screw 65. By rotating the showerhead about the axis, different functions within the showerhead are activated and deactivated.

Referring now to FIGS. 3 and 4, a fluid such as water enters the inlet tube 20 and passes through the handle 15 through channel 70. The water then passes through a channel 75 that passes through a support plate 80, an engine 85, plate 45, apertures 50 and then the nozzle 45. As water passes through channel 75, it encounters a restriction 90 and then expands in diameter 95 to equal that of the bore 100 of the nozzle. The restriction 90 caused the water to accelerate therethrough to offset a reduction of speed caused by the larger diameter 95 encountered at the plate 45.

The plate 45 is fixedly disposed between the engine 85 and the nozzle 40. The apertures 50 direct the water to the nozzle 100 towards the exterior of the bore to give the water escaping from the apertures its shape. By speeding the flow of water through the apertures 50 and along the edges of the nozzle a user feels that more water is being directed to that user's body to give a more enjoyable shower. The nozzle has a flared opening 55 disposed at about a 15° angle to further enhance the pattern and spread of the water flowing from the nozzle. The length L of the nozzle is about 9.6 mm and the width W is 6.0 mm, creating width to length ratio of about 1.6:1.

By using a plurality of smaller nozzles 40 and plates 45 (compared to a single nozzle having 12 apertures of the prior art) and more apertures 50 (e.g., 6 nozzles having four apertures each or a total of 24 apertures), an “aeration” or “atomized” effect produces bigger droplet sizes and less of a mist effect. This is desirable because it produces a better feeling shower spray for a user. Larger nozzles of the prior art create a high “degree of atomization” or very small droplets. This is translated in layman terms as a “misting” spray. This is often considered undesirable because it is colder and stings the skin. It is colder because larger droplets of water retain heat longer, as they exit the showerhead and travel to the skin. Also with a single larger nozzle with fewer apertures, there is more pressure that causes higher spray velocities that causes the spray to sting the user's skin.

The embodiments shown provide the following advantages: individual nozzles can be smaller to minimize misting spray; different arrays can be designed to meet coverage requirements; more orifice holes (4×6=24 instead of 12) lower the velocity without decreasing the droplet size to improve the feel of the shower water; and a balance between “degree of atomization”, velocity and coverage can be maximized to create a more comfortable spray. Though 6 nozzles are shown, 4 and 5 nozzle configurations are also acceptable given the 1.6:1 ratio of the nozzle. Other configurations with different ratios are contemplated herein.

Though these enhancements are shown with the nozzle this embodiment contemplates that each nozzle housing and orifice plate might have different or same shapes to create an ideal bathing experience for a user.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed:

1. A device for use in a shower head that discharges a fluid, said device comprising:
a plurality of nozzles each nozzle having
an opening for discharging the fluid and
a plurality of apertures spaced away from said opening, said opening having a bore through which the fluid flows, and
a face through which said opening extends and wherein said water flowing from said nozzles creates droplets that are large enough to retain heat and slow enough to minimize irritation from the water flowing from each said nozzle.

2. The device of claim 1 wherein said opening includes a flared portion.

3. The device of claim 2 wherein said flared opening extends at about a 15° angle relative to said bore.

4. The device of claim 1 wherein there are greater than twelve apertures distributed within said plurality of nozzles.

5. The device of claim 4 wherein there are greater than 20 apertures distributed within said plurality of nozzles.

6. The device of claim 1 wherein said opening has a length to width ratio of approximately 1.6:1.

7. The device of claim 6 wherein said plurality of nozzles is four to six.

8. A method for providing a user a comfortable shower from a shower head comprising the steps of:
providing water through a first nozzle of said shower head, said nozzle having an outlet, a bore and a plurality of apertures through which the water flows and
providing water through a second nozzle of said shower head and having an outlet, a bore and a plurality of apertures through which the water flows
wherein said water flowing from said nozzles creates droplets that are large enough to retain heat and slow enough to minimize irritation to the user of water flowing from each said nozzle.

9. A device for use in a shower head that discharges a fluid, said device comprising:
a plurality of nozzles each nozzle having
an opening for discharging the fluid and
a plurality of apertures spaced away from said opening, said opening having a bore through which the fluid flows,
wherein said water flowing from said nozzles creates droplets that are large enough to retain heat and slow enough to minimize irritation of water flowing from each said nozzle.

10. The device of claim 9 wherein said opening includes a flared portion.

11. The device of claim 11 wherein said flared opening extends at about a 15° angle relative to said bore.

12. The device of claim 9 wherein there are greater than twelve apertures distributed within said plurality of nozzles.

13. The device of claim 12 wherein there are greater than 20 apertures distributed within said plurality of nozzles.

14. The device of claim 9 wherein said opening has a length to width ratio of approximately 1.6:1.

15. The device of claim 14 wherein said plurality of nozzles is four to six.
